(19) United States
(12) Patent Application Publication
(10) Pub. No.: US 2019/0156643 A1
(43) Pub. Date: May 23, 2019

(54) Child/Individual Tracking System

(71) Applicant: Jennifer Quilter, Virginia Beach, VA (US)

(72) Inventor: Jennifer Quilter, Virginia Beach, VA (US)

(21) Appl. No.: 15/820,677

(22) Filed: Nov. 22, 2017

(51) Int. Cl. G08B 21/02; G08B 25/00

(52) U.S. Cl. CPC G08B 21/0266; G08B 25/009; G08B 21/0294; G08B 21/0275; G08B 21/0288; G08B 21/0269

(57) ABSTRACT

A child or individual tracking system is disclosed. The system is equipped with at least one RFID tag, several RFID readers, a central server computer, and at least one mobile device. A mapped grid of RFID readers are deployed within a public space, such as an amusement park, and an RFID tag sticker is placed on the child to be tracked within the public area. Children are tracked in real-time via the system, and their whereabouts are displayed to parents or guardians via a mobile device application interfaced with the central server computer, helping to prevent lost children and kidnappings. User-defined zones are employed, which enable parents/guardians to be alerted when the child is out of the predefined range centered on the location of the parent/guardian.

### FIELD OF THE PRESENT INVENTION

The present invention relates to RFID-based and GPS-based tracking systems, and more specifically relates to a tracking system for children, mentally disabled persons, or other individuals within public areas such as amusement parks, museums, or other designated facilities to expedite the tracking of lost children/mentally disabled persons/other individuals, helping to prevent lost individuals and kidnappings via an alert system provided to parents and/or guardians of the individual(s) via a mobile device application. The system is complimented by a small GPS-equipped sticker to be worn discreetly on the children/mentally disabled person/other individual.

### BACKGROUND OF THE PRESENT INVENTION

Abductions and kidnappings are known to occur in busy public places such as malls, public parks, and amusement parks. Even if the parents or guardians of a child, mentally disabled person, or other individual are relatively nearby, all it takes is a few seconds of distraction for the worst nightmare of many parents/guardians to come true. Child trafficking remains to exist, and police have more success in locating kidnapped children if minimal time occurs between noticing the missing child, and alerting the police.

While cellular telephones, vehicles, and other mobile electronics are often equipped with a GPS system for precise location data, most children do not have their own smartphone, and therefore do not have an easy way of tracking the child via a GPS tracking system.

Thus, there is a need for a new form of child tracking mechanism which is lightweight, obscured from prominent view, interfaced with a smartphone application, and configured to detect and relay precise location data when certain user-defined parameters are actuated. Such a system is preferably configured to alert parents and/or guardians of the child when the child is detected to be beyond a pre-set radius from the parent and/or guardian. Additionally, such a system is configured to automatically alert police and/or park authorities when the distance between the parents/guardians and the child reaches a predefined threshold.

### SUMMARY OF THE PRESENT INVENTION

This Summary of the Invention is provided to introduce a selection of concepts in a simplified form that are further described below in the Detailed Description. This Summary is not intended to identify key features or essential features of the claimed subject matter, nor is it intended to be used to limit the scope of the claimed subject matter.

The present invention is a child tracking device and system configured to employ a RFID tag and multiple RFID tag readers in order to prevent kidnappings and/or lost children in public spaces, such as amusement parks. The system of the present invention includes a central server interfaced with at least one mobile device, which interface with an RFID tag which is preferably disposed within a sticker or similar clothing accessory to be worn on the child. A GPS transponder is also preferably incorporated into the sticker, and is powered via an internal, disposable battery. RFID readers are preferably disposed throughout the public location, which continually scan for RFID tags on children to determine the location of each child as mapped to the proximal (fixed in position) RFID reader reading the tag. The position of each RFID reader is mapped to facilitate the placement of the child on a spatial grid or map. The system preferably interfaces with at least one mobile device, such as a smartphone, of the parent(s) or guardian(s) of the child to be tracked via a mobile device application (app).

The system of the present invention is configured to constantly track the position of the parent(s) and/or guardian(s) of the child, in order to facilitate the setting of proximity parameters. For example, a parent or guardian may wish to be alerted if their child is more than 40 feet from him/her. Furthermore, the parent or guardian may wish to alert the police if the child is detected to be leaving the mapped grid (i.e. amusement park) without the parent or guardian nearby. Additional parameters may be set by the amusement park authority, or the parent/guardian accompanying the child.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1 depicts a screenshot of the zone setting screen of the mobile device application of the present invention.

FIG. 2 exhibits a screenshot of the mobile device application of the system of the present invention.

FIG. 3 displays a screenshot of the mobile device application of the present invention, depicting an alert screen.

FIG. 4 depicts a screenshot of the mobile device application of the present invention, showing the map feature screen.

FIG. 5 shows a flow chart detailing the process of set-up and use of the system of the present invention by a parent or guardian of a child.

FIG. 6 depicts a view of the RFID and GPS equipped sticker of the present invention, as seen from the front and side.

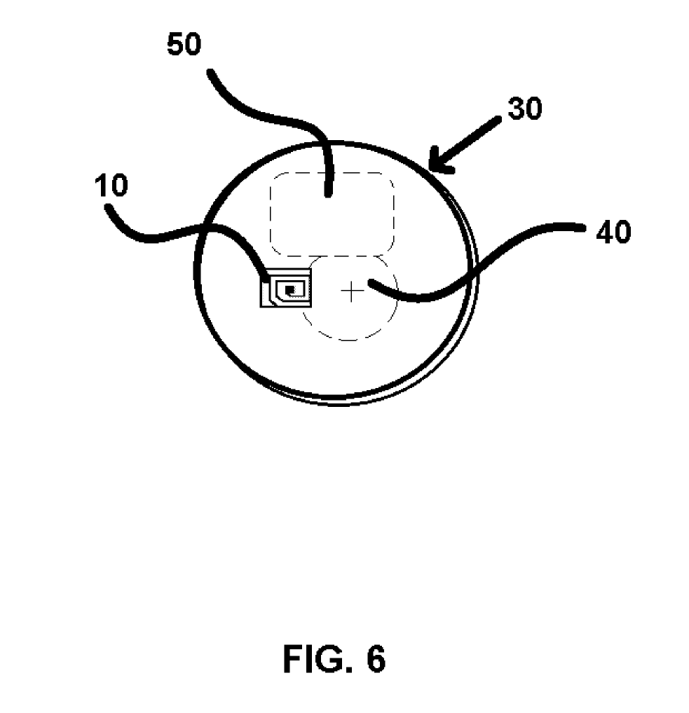

### DETAILED DESCRIPTION OF THE PREFERRED EMBODIMENT

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment, Further, when a particular feature, structure, or characteristic is described in connection with an embodiment, it is submitted that it is within the knowledge of one skilled in the art to effect such feature, structure, or characteristic in connection with other embodiments whether or not explicitly described.

The present invention is a child tracking system configured to employ RFID tags (10) and RFID readers to facilitate obtaining the instant location of a child within a predefined public area, such as an amusement park. The system of the present invention employs stickers (30), which are equipped with an RFID tag (10), a power source (40), and a GPS radio (50). The stickers (30) are designed to be used for a single day, and are to be placed in an inconspicuous location on the skin of a child or individual to be tracked within a public space such as an amusement park, water park, mall, playground, etc. The system of the present invention includes a mobile device application (60), which is designed to run on a mobile device of a parent or guardian responsible for the child/individual. The mobile device application (60) includes several features configured to facilitate tracking of one or more individuals (children, handicapped, etc.), and helps to ensure their safety. For example, the mobile device application (60) is equipped with a GPS map feature (70), which displays, in real-time, the location of the individual equipped with the sticker (30) of the present invention.

It should be understood that the system of the present invention varies from conventional RFID tracking systems employed in amusement parks, which are outfitted by the amusement park authority. Such systems, as prominent within Disney™ theme parks, are managed and distributed to park goers, and are powered and managed by the park's internal systems. In contrast, the present invention acts as an independent option, and further employs GPS in addition to RFID systems, which are configured to interface with the RFID readers distributed throughout the park, mall, or similar public space. In contrast to existing park tracking systems, the present invention employs an inconspicuous sticker (30) which is equipped with the RFID tag (10), the sticker to be placed on the child in a hidden location. Additionally, unlike conventional RFID tracking systems, which tend to employ a bracelet form-factor, the present invention, the present invention employs a removable sticker (30) to be placed directly on the skin.

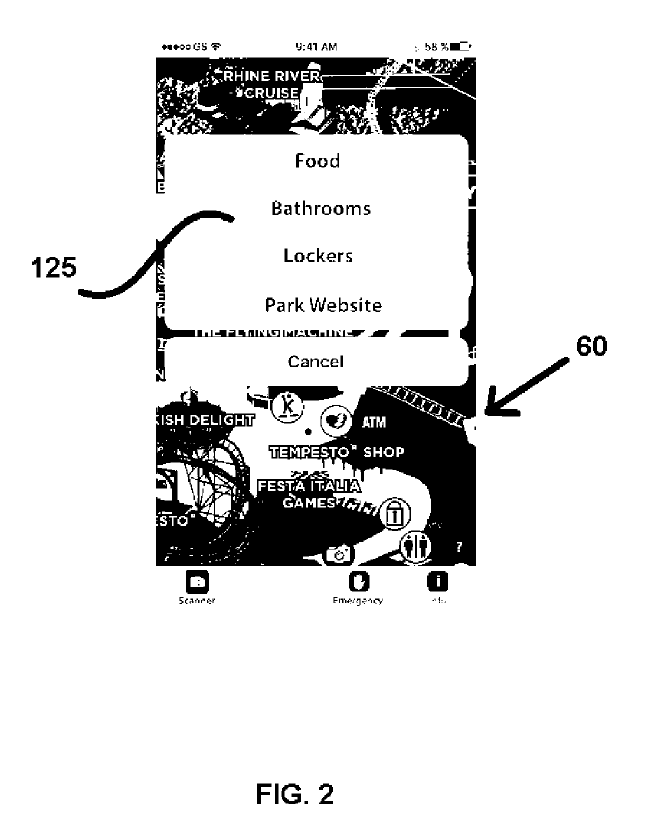

The central server of the system of the present invention is preferably configured to alert the police via phone, text, and other conventional alert mechanisms. The central server of the present invention enacts this alert based on the parameters defined by the parent/guardian within the mobile device application (60) via a define parameters screen (115), or when manually activated within the mobile device application (60) via a ‘contact security’ button (80). A first aid button (95) is preferably also available within the mobile device application (60) to alert onsite paramedics to an emergency if needed. A park information screen (125) is preferably available to the parent/guardian within the mobile device application, which depicts helpful information about the public space, such as the location of bathrooms, lockers, food, etc, as depicted in FIG. 2.

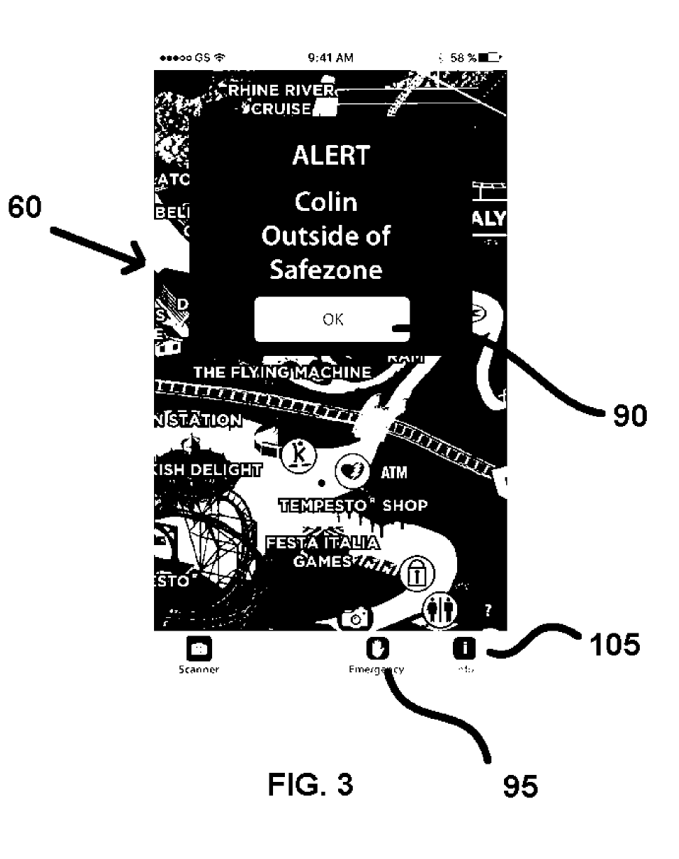

In order to have a moving zone, such as ensuring that the child remains within X feet of the parent or guardian, the parent or guardian must also be tracked, which is accomplished via the internal GPS radio of the mobile device of the parent/guardian. By using the mobile device application (60), the parent/guardian provides permission for the mobile device application to interface with the internal GPS radio of the mobile device, facilitating this feature. When indoors, the NFC receiver may be employed to detect the location of the parent/guardian with respect to the tracked child or individual. Alternatively, Bluetooth™ may be employed to more accurately determine the distance between the tracked child equipped with the sticker (30), and the mobile device of the parent/guardian. When the mobile device application (60) detects that the child/individual has ventured out of the defined zone, an alert screen (90) is shown, as depicted in FIG. 3.

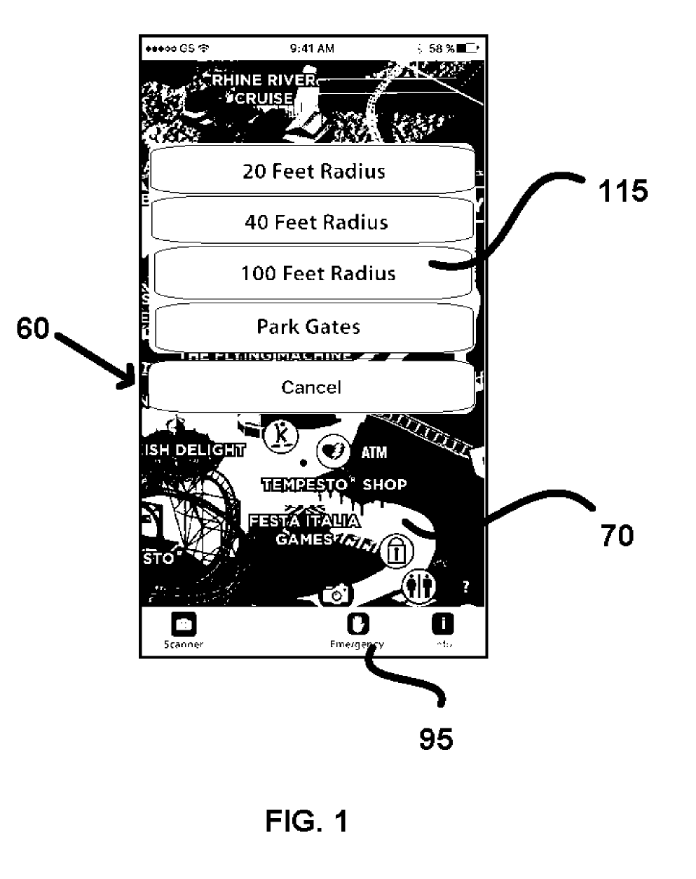

Preferred embodiments of the mobile device application (60) of the present invention preferably appear similar to FIGS. 1-4. A personal identification information input button (105) is preferably available at the bottom of the mobile device application (60), which allows parents/guardians to provide personal information of the child/individual to be used by park security or police in the event of the tracked child being lost.

There are preferably a wide variety of user-defined parameters which may be set within the mobile device application of the present invention. For example, a lenient parent may opt to only be alerted if the child is detected leaving the park without the parent following shortly after. In contrast, other parents/guardians may wish to set more specific parameters, such as to be alerted when the child ventures more than 50 feet from the mobile device of the parent/guardian. If a child/individual equipped with the sticker (30) leaves the park, and the parent/guardian is alerted, the parent/guardian may select an option stating that the parent allowed the child to leave, such as with a friend or other guardian not tracked by the system. In other embodiments, minimum parameters or guidelines may be determined by the theme park or similar public space equipped with the system of the present invention

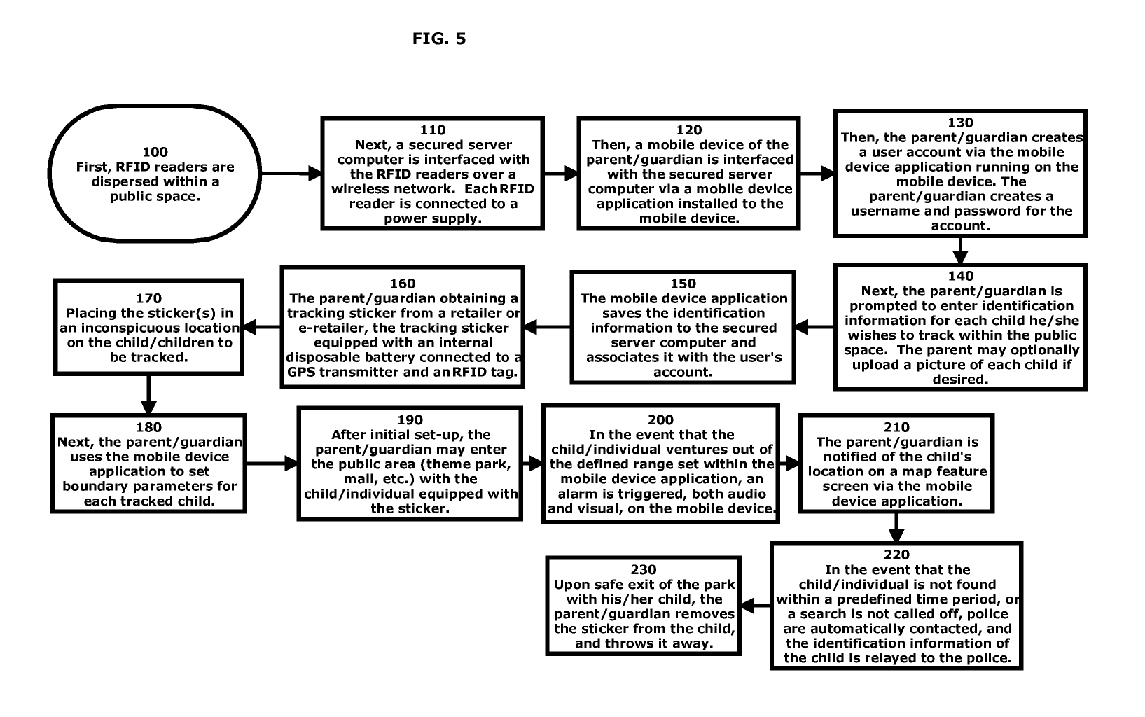

The preferred process of set-up and use of the system of the present invention, as shown in FIG. 5, is as follows:

1. First, RFID readers are dispersed within a public space. (100)

2. Next, a secured server computer is interfaced with the RFID readers over a wireless network. Each RFID reader is connected to a power supply. (110)

3. Then, a mobile device of the parent/guardian is interfaced with the secured server computer via a mobile device application installed to the mobile device. (120)

4. Then, the parent/guardian creates a user account via the mobile device application running on the mobile device. The parent/guardian creates a username and password for the account. (130)

5. Next, the parent/guardian is prompted to enter identification information for each child he/she wishes to track within the public space. The parent may optionally upload a picture of each child if desired. (140)

6. The mobile device application saves the identification information to the secured server computer and associates it with the user's account. (150)

7. The parent/guardian obtaining a tracking sticker from a retailer or e-retailer, the tracking sticker equipped with an internal disposable battery connected to a GPS transmitter and an RFID tag. (160) The sticker is scanned via a QR code disposed on the sticker to link the specific sticker to the mobile device application, and in turn, the child/individual to wear the sticker.

8. Placing the sticker(s) in an inconspicuous location on the child/children to be tracked. (170)

9. Next, the parent/guardian uses the mobile device application to set boundary parameters for each tracked child. (180) Parameters include, but are not limited to a maximum distance from the mobile device of the parent/guardian that the child may venture prior to an alarm sounding, maximum range the child may venture prior to an alarm sounding, sounding an alarm once the child has left a specific, defined area, or sounding an alarm upon detection of the child or children leaving the park/public space.

10. After initial set-up, the parent/guardian may enter the public area (theme park, mall, etc.) with the child/individual equipped with the sticker. (190)

11. In the event that the child/individual ventures out of the defined range set within the mobile device application, an alarm is triggered, both audio and visual, on the mobile device. (200) The screen of the mobile device depicts the alarm as shown in FIG. 3.

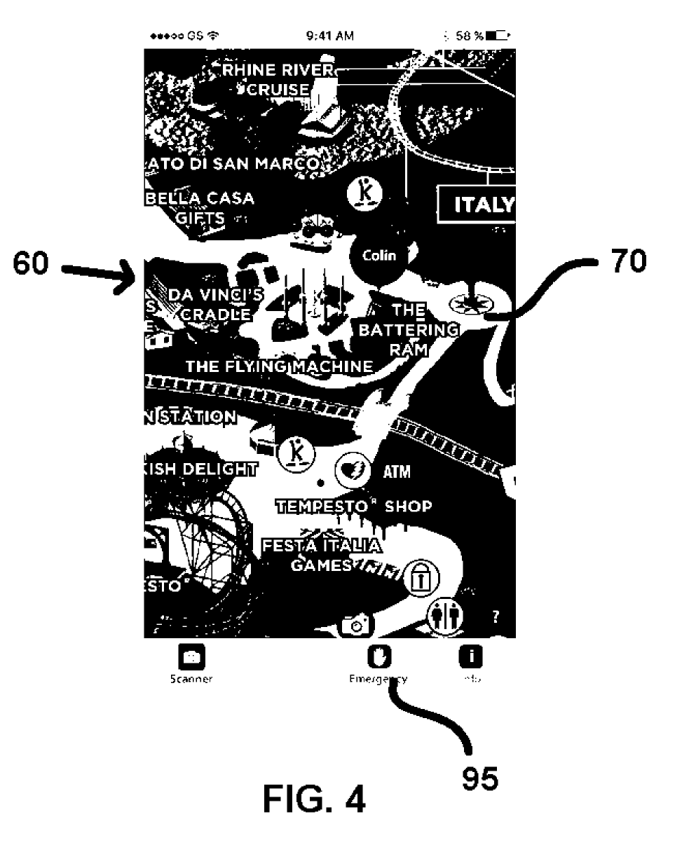

12. The parent/guardian is notified of the child's location on a map feature screen via the mobile device application. (210) The child's location is depicted on the map screen, as shown in FIG. 4.

13. In the event that the child/individual is not found within a predefined time period, or a search is not called off, police are automatically contacted, and the identification information of the child is relayed to the police. (220) The parent/guardian may optionally call the police directly from the mobile device application if desired, via an emergency contact button (85).

14. Upon safe exit of the park with his/her child, the parent/guardian removes the sticker from the child, and throws it away. (230)

It should be understood that the mobile device application (60) of the present invention is preferably equipped with the following features:
1. A detailed GPS map of the amusement park or other designated public area (museum, city, mall, etc.) is available to the parent/guardian via the GPS map feature (70) screen. A list of available places (equipped with the RFID readers of the present invention, is provided to choose from. Such places are outfitted with the RFID technology to facilitate indoor tracking of the child/individual, however other locations that are outdoors may solely rely on GPS for the tracking of the child/individual via the GPS radio (50) embedded within the sticker (30) of the present invention.
2. From the mobile device application, parents/guardians are provided the ability to scan each individual sticker using a bar code or NFC scanner, and designate it to a particular person by typing in their name/initials in the mobile device application.
3. A voice command feature is preferably available within the mobile device application, which allows a parent/guardian to verbally state, “find Colin” or “find CQ” for example, which would then zoom into his location on the GPS map feature (70) automatically.
4. The GPS map displayed on the mobile device application (via the GPS map feature (70)) preferably provides multiple map views, including but not limited to a Satellite view and a standard map view. It is envisioned that the theme park or similar public space may augment the map displayed within the GPS map feature (70) with additional details of the location, including food vendors, restrooms, rides, and other attractions.
5. A Security button (80) is preferably available within the mobile device application, which automatically displays and/or dials a security phone number, and alerts park security to a problem. It is envisioned that security personnel may be able to view a map of a customer on his/her mobile device if a parent/guardian on the system is issued an alert.
6. A first aid button (90) is preferably available to instantly call for medical assistance if needed.
7. An automatic alert may be issued when the individual (child) wearing a sticker (30) goes out of boundaries of the park/venue. For example, if they entered parking lot an alarm is configured to sound on the mobile device application (60)
8. The mobile device application (60) also preferably provides website links to the theme park, venue, or other public space equipped with the system of the present invention.
9. Additionally, links are also preferably shown for food services and bathroom locations within the public space outfitted with the system of the present invention.
10. The mobile device application (60) is free to download from popular conventional mobile device ‘app’ stores, such as the Google™ Play Store™, and the Apple™ App Store™.

Features of the sticker (30) of the present invention preferably include:
1. Each sticker (30) is small, square or rectangular in shape, waterproof, and disposable.
2. The sticker (30) is equipped with a strong, waterproof adhesive so that it will not fall off easily, even when swimming. The adhesive employed is preferably safe for use directly on the skin of the child. Adhesive is only disposed on a rear side of the sticker (30).
3. A GPS radio (50) is permanently embedded within the sticker (30).
4. The sticker is preferably equipped with a bar code to facilitate linking the specific sticker (30) to a specific child's personal identification information for scanning into app on sticker.
5. A logo or picture may be disposed on a front of the sticker (30).
6. It is envisioned that the stickers (30) may be purchased in packages of 4, 8, 12, or 20 stickers.

It should be understood that the present invention is different from conventional item or vehicle tracking systems presently on the market. For example, the present invention is meant for locating people and not inanimate objects (such as phone, keys, backpack, etc.) Additionally, the sticker (30) of the present invention may be placed anywhere on the body, including on the skin, and is waterproof. The stickers (30) are disposable, and are not meant for use of more than one day.

The mobile device application (60) of the present invention is preferably specific for a given location, i.e. waterpark/city/mall/museum. Additionally, the mobile device application (60) displays a GPS map of the area, rather than a radar map.

Additionally, it should be understood that the system of the present invention need not be used solely for the tracking of children, but may be employed for increased safety for families, children, elderly, large groups, and/or mentally handicapped individuals.

The power supply of the stickers (30) of the present invention is not meant to last more than 8-12 hours. As such, the parent/guardian should throw the sticker (30) away at the end of the day. The power supply of the sticker (30) is preferably a thin button cell battery, which can power the GPS radio (50) for the day. If the parent/guardian wishes to track his/her child for a second day, then the parent/guardian is required to purchase additional stickers (30). To reiterate, the sticker (30) of the present invention is not preferably equipped with a rechargeable battery.

The technology of the present invention is meant for children and adults who would not have smart phones, especially in public locations not conducive to having a phone on ones person, such as a water park. There is to only be one designated adult owned mobile device, equipped with the mobile device application, which tracks each individual equipped with a sticker (30). It is envisioned that some embodiments of the present invention are equipped with a Bluetooth™ radio, which may be used to facilitate proximity based tracking to the mobile device. In such embodiments, the sticker (30) may be linked to the Bluetooth radio of the mobile device of the parent/guardian, allowing the parent/guardian to be alerted in the event that the child ventures more than 30 feet (approximately) from the mobile device of the parent/guardian. The limited range of Bluetooth technology only permits a maximum of 30 to 40 feet before an alarm is triggered.

Preferred embodiments of the present invention would solely employ GPS tracking technology, especially in outdoor public spaces, and RFID technology is to be relegated to use when the child is indoors.

Alternate embodiments of the system of the present invention include, but are not limited to variations in size, shape, and scale of the stickers (30). Additionally, it is envisioned that the mobile device application (60) may be configured to function in tandem with a smartwatch, smart glasses, such as Google™ Glass™, or similar wearable technologies. Additionally, vibrations may be enacted via the vibration alert motor found within conventional mobile devices. As such, the mobile device of the parent/guardian may optionally be configured to vibrate when an alert is issued, in addition to an audio-visual alert.

It should be understood that the system of the present invention predominantly employs the GPS radio (50) of the sticker (30) to track the child/individual in real-time, and display the current location on the GPS map feature (70) of the mobile device application (60). The RFID tag (10) of the sticker (30) is preferably configured to augment the efficacy of the GPS radio (50) to locate the child/individual, especially when the child/individual ventures into indoor areas of the public space. It is envisioned that the RFID readers are to be furnished by the management of the public space, and that alternate embodiments of the mobile device application (60) may be made available by each public space in which child/individuals may wish to be tracked.

Additionally, it should be understood that the present invention is envisioned for use on children, mentally disabled individuals, or other individuals which may require additional attention when in a public area. As such, the present invention is not limited to use on children.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

1. A method for tracking a child/individual within a public space equipped with RFID readers comprising:
interfacing a secured server computer with the RFID readers over a wireless network;
wherein the RFID readers are distributed within indoor areas of the public space;
interfacing a mobile device to the secured server computer via a mobile device application;
creating a login and password;
uploading a photo of the child/individual to be tracked to the secured server computer via the mobile device application;
inputting information about the child/individual via the mobile device application;
the mobile device application saving the information to the secured server computer;
placing a sticker on any skin of the child/individual in a location obscured by clothing;
wherein the sticker contains a power source, a RFID tag and a GPS radio;
wherein the power source is in communication with the RFID tag and the GPS radio;
linking a unique code of the sticker to the child/individual via the mobile device application;
defining boundary parameters for the child/individual equipped with the sticker via the mobile device application;
wherein the boundary parameters represent range limits in distance from the mobile device running the mobile device application in addition to physical boundaries of the public space from which the child/individual may venture prior to triggering an alarm; and
wherein the boundary parameters may be overridden if the parent/guardian provides permission.

2. The method of claim 1, wherein the sticker is hidden under an article of clothing; and
wherein the sticker is waterproof.

3. The method of claim 1, further comprising:
entering the public space equipped with the RFID readers;
the child/individual veering out of the defined range set within the boundary parameters; and
the mobile device application notifying a parent/guardian of the child/individual's location via the mobile device application.

4. The method of claim 3, further comprising:
the child/individual failing to return to a location within the defined boundary parameters; and
the mobile device application contacting security.

5. The method of claim 4, wherein the information about the child/individual is relayed to security.

6. The method of claim 3, further comprising:
the child/individual failing to return to a location within the defined boundary parameters; and
the mobile device application contacting Police.

7. The method of claim 6, wherein the information about the child/individual is relayed to Police.

8. A system for tracking a child/individual to prevent missing persons comprising:
a sticker, said sticker containing a RFID tag, a GPS radio, and a power source;
wherein said sticker has a front and a rear;
adhesive, said adhesive disposed on said rear;
wherein said sticker is waterproof;
a QR code, said QR code disposed on said rear; and
wherein said power source is in communication with said GPS radio and said RFID tag.

9. The system of claim 8, further comprising:
a mobile device application, said mobile device application running on a mobile device;
wherein said mobile device is configured to interface with said sticker wirelessly; and
a GPS map feature screen of the mobile device application, said GPS map feature screen configured to display the location of the sticker on a map in real-time.

10. The system of claim 9, further comprising:
a secured server, said secured server in communication with said mobile device application;
a child/individual information input screen, said child/individual information input screen configured to accept personal information about the child/individual;
wherein said personal information is saved to said secured server; and
wherein said personal information is relayed to Police when the child/individual ventures out of a defined range.

11. The method of claim 3, further comprising:
the parent/guardian selecting an option within the mobile device application stating that the parent/guardian provides permission for the child/individual to leave the boundary parameters with a second individual.

12. The method of claim 3, further comprising:
the parent/guardian selecting an option within the mobile device application stating that the parent/guardian provides permission for the child/individual to leave the boundary parameters, preventing the mobile device application from alerting Police.

13. The method of claim 2, wherein the article of clothing is selected from the following group: a bathing suit, underwear, a diaper, a shirt, shorts, socks, and shoes.
